(19) United States
(12) Patent Application Publication
(10) Pub. No.: US 2025/0276603 A1
(43) Pub. Date: Sep. 4, 2025

(54) CHARGE CONTROLLER

(71) Applicant: TOYOTA JIDOSHA KABUSHIKI KAISHA, Toyota-shi, (JP)

(72) Inventors: Keisuke FUKUOKA, Fujieda-shi (JP); Yoshihiro SAKAYANAGI SAKAYANAGI, Mishima-shi (JP); Midori SUGIYAMA, Susono-shi (JP)

(73) Assignee: TOYOTA JIDOSHA KABUSHIKI KAISHA, Toyota-shi (JP)

(21) Appl. No.: 19/016,189

(22) Filed: Jan. 10, 2025

(30) Foreign Application Priority Data
Feb. 29, 2024 (JP) 2024-030479

(51) Int. Cl. B60L 53/67; H02J 7/00

(52) U.S. Cl. CPC B60L 53/67; H02J 7/0071; B60L 2250/14

(57) ABSTRACT

A charge controller includes a controller that controls a first charger, which corresponds to charging based on a charging schedule in which date and time and power instruction value of charging to a vehicle are provided as a pair, and a second charger, which does not correspond to the charging based on the charging schedule. Further the controller obtains the charging schedule from a user of the vehicle, outputs, to the first charger, charging schedule and further outputs, when the last specified power instruction of the charging schedule is 0 kW, a charging stop instruction, and output, to the said second charger, a specified power instruction value at the date and time specified in the charging schedule, and further outputs, when the power instruction value specified in the charging schedule is 0 kw, the charging stop instruction.

### CROSS-REFERENCE TO RELATED APPLICATION(S)

The present application claims priority to and incorporates by reference the entire contents of Japanese Patent Application No. 2024-030479 filed in Japan on Feb. 29, 2024.

### BACKGROUND

The present disclosure relates to a charge controller.

Japanese Patent No. 5582824 discloses a technique for a charge controller for charging by selecting an arbitrary charging pattern from a plurality of charging patterns by each user. When, during charging of a vehicle, there is charging instructions from another vehicle, if the charging becomes excessive, the charge controller stops charging of the vehicle.

### SUMMARY

There is a need for providing a charge controller that enables manual charging at power indications other than 0 kW even when communication interruptions or the like occur.

According to an embodiment, a charge controller includes a controller that controls a first charger, which corresponds to charging based on a charging schedule in which date and time and power instruction value of charging to a vehicle are provided as a pair, and a second charger, which does not correspond to the charging based on the charging schedule. Further the controller obtains the charging schedule from a user of the vehicle, outputs, to the first charger, charging schedule and further outputs, when the last specified power instruction of the charging schedule is 0 kW, a charging stop instruction, and output, to the said second charger, a specified power instruction value at the date and time specified in the charging schedule, and further outputs, when the power instruction value specified in the charging schedule is 0 kW, the charging stop instruction.

### BRIEF DESCRIPTION OF THE DRAWINGS

FIG. 1 is a block diagram illustrating an overall configuration of a charge control system including a charge controller according to an embodiment; and

FIG. 2 is a diagram for explaining a flow of a charge control method that the charge controller according to the embodiment executes.

### DETAILED DESCRIPTION

In the technique disclosed in Japanese Patent No. 5582824, for example, when a communication interruption or the like occurs when the power instruction value of the charging for the vehicle is 0 kW, since the power instruction value cannot be changed to a value other than 0 kW until the communication is recovered, so that manual charging with a power instruction value other than 0 kw becomes difficult.

A charge controller according to an embodiment of the present disclosure will be described with reference to the drawings. In addition, components in the following embodiments include those which can be substituted and easily by those skilled in the art, or those which are substantially the same.

### Charge Control System

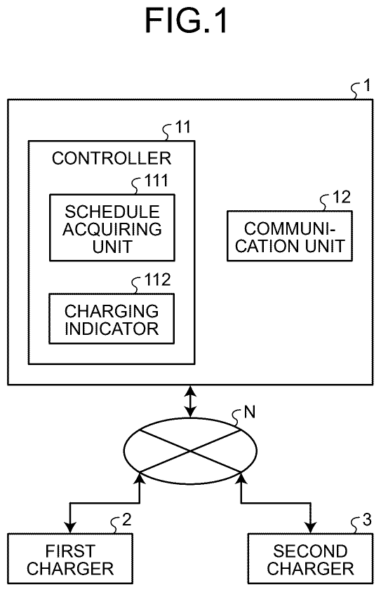

A charge control system including a charge controller according to the embodiment will be described with reference to FIG. 1. The charging control system, as illustrated in FIG. 1, has a Charge controller 1, a first charger 2, and a second charger 3.

Charge controller 1, the first charger 2 and the second charger 3 is configured to communicate with each other through the network N.

The network N is composed of, for example, an Internet line network, a mobile phone line network or the like.

The charge controller 1 is for controlling the first charger 2 and the second charger 3 for charging to the vehicle. Incidentally, the vehicle described above, for example, a Plug-in Hybrid Electric Vehicle (PHEV), an electric vehicle such as a Battery Electric Vehicle (BEV). The charge controller 1 is realized by a general-purpose computer such as a workstation or a personal computer, for example. Further, the charge controller 1 includes a controller 11, and a communication unit 12.

The controller 11, for example, is realized by a processor made of a Central Processing Unit (CPU) or the like, a memory (main storage unit) consisting of a Random Access Memory (RAM) and a Read Only Memory (ROM) or the like. The controller 11 functions as a schedule acquiring unit 111 and a charging indicator 112 by executing various programs.

The schedule acquiring unit 111 acquires the charging schedule of the vehicle from the user of the vehicle, for example.

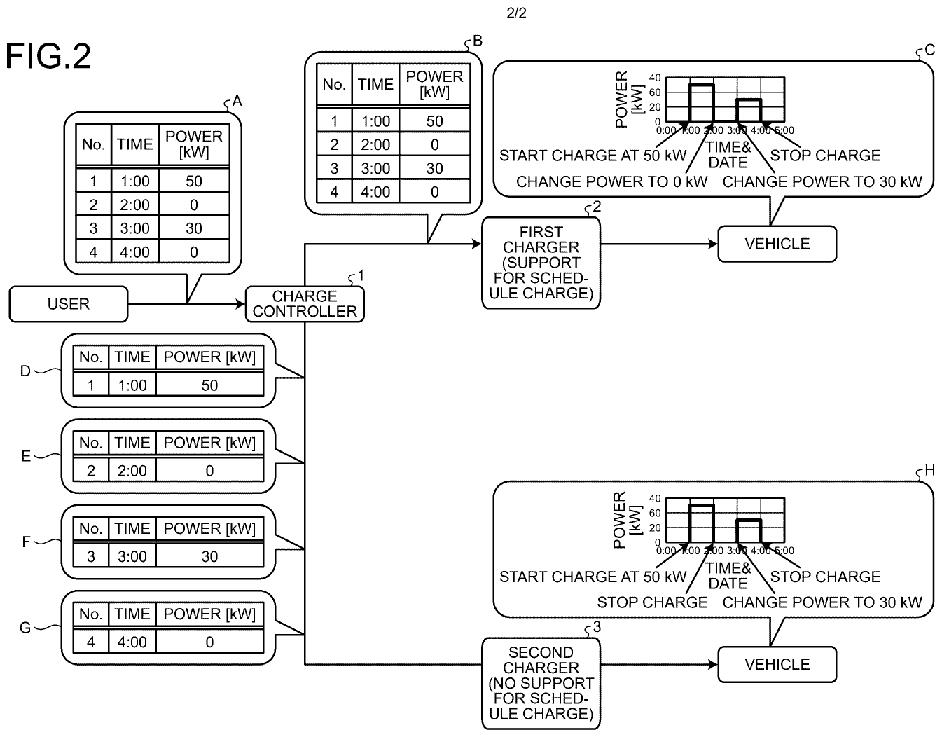

This “charging schedule” indicates the date and time of charging to the vehicle (time) and the power instruction value (power command value) is a pair of data (see FIG. 2). The schedule acquiring unit 111 may acquire the charging schedule (via the network N) from the user of the vehicle as described above, or from a business office or the like that manages the operation of the plurality of vehicles, the charging schedule of the vehicle it may be.

For example, when acquiring the charging schedule from the business operator or the like, the time and the vehicle of entry and exit of the vehicle is determined in advance, the charging schedule is created based on these.

The charging indicator 112 instructs the charging of the vehicle to the first charger 2 and the second charger 3. The charging indicator 112 outputs (transmits) a charging schedule obtained by the schedule acquiring unit 111 to the first charger 2. That is, the charging indicator 112 outputs the charging schedule as it is to the first charger 2 corresponding to the charging based on the charging schedule (hereinafter, referred to as “schedule charging”).

Further, when the last specified power instruction of the charging schedule is 0 kw, the charging indicator 112 outputs a charging stop instruction to the first charger 2 (charging stop command). That is, when the last specified power instruction value of the charging schedule is 0 kw, the charging indicator 112 outputs the charging schedule along with an instruction to stop the charging at the end of the schedule to the first charger 2.

The charging indicator 112 does not directly output the charging schedule obtained by the schedule acquiring unit 111 to the second charger 3, but outputs the specified power instruction value at the date and time specified in the charging schedule. That is, the charging indicator 112 outputs the power instruction value each time in accordance with the date and time described in the charging schedule to the second charger 3 that does not correspond to the schedule charging.

Further, the charging indicator 112, when the power instruction specified in the charging schedule is 0 kW, outputs a charging stop instruction to the second charger 3. That is, the charging indicator 112, when the power instruction to be output to the second charger 3 is 0 kw, outputs an instruction to the effect that stopping charging to the second charger 3.

The communication unit 12 includes, for example, a Local Area Network (LAN) interface board, a wireless communication circuitry for wireless communication, and the like. The communication unit 12, by communication through the network N, exchanges information between the first charger 2 and the second charger 3.

The first charger 2 is a device for performing charging to the vehicle, for example, and is installed in a charging station or business office or the like. The first charger 2 is a charging facility that supports scheduled charging. Further, the first charger 2 reads the charging schedule acquired from the charging indicator 112 and changes the charging power to the vehicle, so that the specified power instruction value is obtained at the date and time specified by the charging schedule.

The second charger 3 is a device for performing charging to the vehicle, for example, and is installed in a charging station or business office or the like. The second charger 3 is a charging facility that does not support scheduled charging. The second charger 3 charges power to the vehicle, so that the power corresponds to the power instruction value acquired from the charging indicator 112.

### Charge Control Method

A flow of the charge control method performed by the charge controller according to the embodiment will be described with reference to FIG. 2. Incidentally, FIG. 2 illustrates an example of the case of advancing from left to right as a time series.

First, the schedule acquiring unit 111 acquires the charging schedule from the user of the vehicle (see A of FIG. 2). The charge schedule illustrated in FIG. 2 has four schedules from No. 1 to No. 4. No. 1 is a schedule to charge the power of “50 KW (power instruction value)” on “1:00”, and No. 2 is a schedule to charge the power of “0 kw (power instruction value)” on “2:00”. Further, No. 3 is a schedule for charging the power of the “30 KW (power instruction value)” on “3:00”, and No. 4 is a schedule for charging the power of the “0 KW (power instruction value)” on “4:00”.

Subsequently, the charging indicator 112 outputs a charging schedule to the first charger 2, (see B in FIG. 2). That is, the charging indicator 112 outputs a plurality of charging schedule collectively to the first charger 2.

In the charging schedule illustrated in FIG. 2, the last specified power indication of the charging schedule is 0 KW (see No. 4). Therefore, the charging indicator 112 outputs a charging stop instruction together with the charging schedule to the first charger 2. By performing the above process, in the vehicle, first, charging is started at “50 KW”, then the power is changed to “0 kW”, then the power is changed to “30 kW”, and finally charging is stopped based on the charging stop instruction (see C in FIG. 2).

Further, the charging indicator 112, sequentially outputs the specified power instruction values to the second charger 3 at the date and time specified in the charging schedule, (see D, E, F, G of FIG. 2). That is, the charging indicator 112 outputs the charging schedule one by one to the second charger 3.

In the charging schedule illustrated in FIG. 2, the second and last specified power readings of the charging schedule are 0 kW (see No. 2, 4). Therefore, when outputting the schedule of No. 2, 4 to the second charger 3, the charging indicator 112 output the charging stop instruction. By performing the above process, in the vehicle, first, charging is started at “50 kW”, then charging is stopped based on the charging stop instruction, then charging is started at “30 kW”, and finally charging is stopped based on the charging stop instruction (see H in FIG. 2). Thus, even in the second charger 3 that does not correspond to the schedule charging, it is possible to perform the same charging control as the first charger 2 that corresponds to the schedule charging.

According to the charge controller according to the embodiment described above, when the power instruction value specified in the charge schedule is 0 kw, by outputting a charge stop instruction, even when a communication interruption or the like occurs, it is possible to manually charge at a power instruction value other than 0 kW.

That is, in a charge controller in the related art, for example, when the communication between the charger and the charge controller specifying the power instruction 0 kw is interrupted, since it is impossible to change the charging power from 0 kW until the communication is restored, so that charging to the vehicle was practically impossible.

On the other hand, in the charge controller according to the embodiment, when the power instruction of the charging schedule is 0 kW, the first charger 2 and the second charger 3 do not send the power instruction of 0 kw but send the charging stop instruction to stop charging. Thus, even if the communication is interrupted, for example, based on the power instruction value before the power instruction value 0 kW of the charging schedule (e.g., “30 kW” in No. 3 of the charging schedule in FIG. 2), manual charging can be performed.

According to the present disclosure, when the power instruction value specified by the charging schedule is 0 kw, by outputting the charging stop instruction, even when a communication interruption or the like occurs, it is possible to manually charge at a power instruction value other than 0 kW.

Further effects and variations can be readily derived by one skilled in the art. Thus, the broader aspects of the invention are not limited to the specific details and representative embodiments represented and described above. Accordingly, various changes may be made without departing from the spirit or scope of the overall inventive concept defined by the appended claims and their equivalents.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A charge controller comprises a controller that controls a first charger, which corresponds to charging based on a charging schedule in which date and time and power instruction value of charging to a vehicle are provided as a pair, and a second charger, which does not correspond to the charging based on the charging schedule, wherein
the controller is configured to
obtain the charging schedule from a user of the vehicle,
output, to the first charger, charging schedule and further output, when the last specified power instruction of the charging schedule is 0 kW, a charging stop instruction, and
output, to the said second charger, a specified power instruction value at the date and time specified in the charging schedule, and further output, when the power instruction value specified in the charging schedule is 0 kw, the charging stop instruction.
